(19) United States
(12) Patent Application Publication
(10) Pub. No.: US 2026/0335162 A1
(43) Pub. Date: Oct. 29, 2026

(54) SEATED PATIENT POSITIONER

(71) Applicant: EHOB, Inc., Indianapolis, IN (US)

(72) Inventors: Heike Roessiger, Indianapolis, IN (US); Jared Cohen, Indianapolis, IN (US); Isaac Oberhausen, Fort Wayne, IN (US); Chris Perkins, Carmel, IN (US); Gregory Konkle, Indianapolis, IN (US)

(21) Appl. No.: 19/656,734

(22) Filed: Apr. 23, 2026

Related U.S. Application Data
(60) Provisional application No. 63/793,814, filed on Apr. 24, 2025.
(60) Provisional application No. 63/930,279, filed on Dec. 3, 2025.

(51) Int. Cl. A61G 15/12; A61G 5/14; A61G 7/10

(52) U.S. Cl. CPC A61G 15/12; A61G 5/14; A61G 7/1038

(57) ABSTRACT

A seated patient positioner for placement on a chair comprises a seating segment including an off-loading element, a seating surface and an opposite interface surface. A base segment includes an elongated sheet sized to cover the seat of the chair, with a top surface and an opposite slip-resistant bottom surface which contacts the seat of the chair and provides a friction surface to resist slipping between the base segment and the seat of the chair. A fold segment connects the seating segment to the elongated sheet of the base segment, and is configured for the seating segment to be folded over onto the base segment with the interface surface in contact with the top surface of the base segment. A chair engagement feature is provided for engaging the seated patient positioner to the chair to resist dislodgment of the positioner from the chair.

### PRIORITY CLAIM

This application is a utility filing from and claims priority U.S. Provisional Application No. 63/793,814, filed on Apr. 24, 2025, and U.S. Provisional Application No. 63/930,279, filed on Dec. 3, 2025. The entire disclosures of these provisional applications are incorporated herein by reference.

### BACKGROUND

The present disclosure generally relates to an apparatus and method for positioning a person in a seated position, and, more particularly, to an apparatus configured to facilitate moving the person onto and off the chair.

Nurses and other caregivers at hospitals, assisted living facilities, and other locations often care for patients that have limited or no mobility, many of whom are critically ill or injured. The caregivers of such patients can often encounter difficulties in positioning the patients in seated positions and/or maintaining the patients in seated positions, due to this decreased mobility. This can make the use of chairs (including traditional chairs, wheelchairs, and other seating apparatuses) difficult on both the patient and the caregiver. Patients with decreased mobility may tend to slide downward and forward in a chair after proper positioning, which can even pose challenges with patients having sufficient mobility to position themselves in the chair. Further, pressure ulcers can pose problems for patients spending significant time in seated and/or lying positions.

Patients with severely decreased mobility may need to be pushed or pulled backward in the chair to be seated in the proper position, which can cause strain on the caregiver. Likewise, the patient may need to be pushed or pulled to rise from the chair.

Existing apparatuses and methods often do not provide adequate assistance in positioning a patient in a seated position, transferring a patient from the seated position and/or maintaining the patient in the seated position. Existing apparatuses and methods also often may not provide adequate protection against the risk of falls and pressure ulcers when decreased mobility patients are placed in chairs.

The present invention seeks to overcome certain of these limitations and other drawbacks of existing apparatuses, systems, and methods, and to provide new features not heretofore available.

### SUMMARY OF THE DISCLOSURE

A seated patient positioner for placement on a chair comprises a seating segment including an off-loading element, such as a static-air cushion, disposed within a cushion case, a seating surface which contacts the patient when the patient is seated on the positioner and an opposite interface surface, wherein the seating segment is sized to substantially cover the seat of the chair. The positioner further includes a base segment including an elongated sheet sized to at least substantially cover the seat of the chair, the elongated sheet having a top surface and an opposite slip-resistant bottom surface which contacts the seat of the chair when the seated patient positioner is placed on the chair and provides a friction surface to resist slipping between the base segment and the seat of the chair. A fold segment connects the seating segment to the elongated sheet of the base segment, and is configured for the seating segment to be folded over onto the base segment with the interface surface in contact with the top surface of the base segment. A chair engagement feature is provided for engaging the seated patient positioner to the chair to resist dislodgment of the positioner from the chair.

In another embodiment, a seated patient positioner for placement on a chair comprises a seating segment including an off-loading element, such as a static air cushion, disposed in a cushion case, a seating surface which contacts the patient when the patient is seated on the positioner and an opposite interface surface, wherein the seating segment is sized to substantially cover the seat of the chair. The positioner further includes a base segment sized to at least substantially cover the seat of the chair, the base segment including a bottom sheet for contacting the seat of the chair and a top sheet forming a casing with the bottom sheet. The casing is connected to a tubular air intake sock connected at one end thereof to an interior of the casing and including an inlet fitting at an opposite end configured to be connected to an external air supply. A fold segment connects the seating segment and the elongated sheet of the base segment, and is configured for the seating segment to be folded over onto the base segment with the interface surface in contact with the top surface of the base segment. A chair engagement feature is provided for engaging the seated patient positioner to the chair to resist dislodgment of the positioner from the chair. In one feature, the top sheet includes a plurality of apertures for flow of air from the interior of the casing, when air is provided through the air intake sock, to form an air cushion between the base segment and the seating segment when the seating segment is folded over onto the base segment.

The base segment of the seated patient positioner can be sized to cover the seat of the chair and to extend up onto the back of the chair. In certain embodiments, a static air cushion is provided at the portion of the patient positioner at the back of the chair. In another feature, a wedge can be disposed at the base segment that is arranged for the seating segment to be folded over onto the wedge, wherein the wedge is angled upward toward the fold segment of the positioner.

### DESCRIPTION OF THE DRAWINGS

FIG. 1 is a top view of a seated patient positioner according to one embodiment of the present disclosure.

FIG. 2 is a side view of the seated patient positioner shown in FIG. 1.

FIG. 3 is an enlarged view of a cushion case of the seated patient positioner of the previous figures.

FIG. 4 is a top perspective view of the seated patient positioner of FIGS. 1-2.

FIG. 5 is a perspective view of the seated patient positioner of the previous figures, shown with the positioner in an initial position disposed in a chair.

FIG. 6 is a perspective view of the seated patient positioner in a final position disposed in a chair and ready to receive a patient.

FIG. 7 is a perspective view at the rear of the chair showing the harness of the seated patient position of FIGS. 1-6 for fixing the positioner to the chair back.

FIG. 8 is a top view of a seated patient positioner according to another embodiment of the present disclosure.

FIG. 9 is a side view of the seated patient positioner shown in FIG. 8.

FIG. 10 is a side view of the seated patient positioner of FIGS. 8-9 shown in an intermediate position on a chair.

FIG. 11 is a perspective view of the cushion case for the back segment of the seated patient positioner of FIGS. 8-10, showing the orientation of the removable cushion relative to the cushion case.

FIG. 12 is a perspective view of the seated patient positioner of FIGS. 8-10 shown with the seating segment folded over onto the base segment.

FIG. 13 is a perspective view of the seated patient positioner of FIGS. 8-10 in a first position partially disposed in a chair.

FIG. 14 is a perspective view of the seated patient positioner of FIGS. 8-10 in a final position on the chair ready for a patient to be seated.

FIG. 15 is a perspective view of the rear of the chair with the seated patient positioner of FIGS. 8-10 mounted thereon, showing the harness of the positioner.

FIG. 16 is a top view of a seated patient positioner according to another embodiment of the present disclosure.

FIG. 17 is a side view of the seated patient positioner shown in FIG. 16.

FIG. 18 is a plan view of a seated patient positioner according to a further embodiment.

FIG. 19 is a side view of the seated patient positioner shown in FIG. 18.

FIG. 20 is a top view of the seated patient positioner shown in FIGS. 18-19 shown with the seating segment folded over the base segment of the positioner.

FIG. 21 is a rear view of the seated patient positioner shown in FIG. 20 showing the flaps connecting the seating segment to the base segment.

FIG. 22 is a side perspective view of the seated patient positioner of FIGS. 20-21.

FIG. 23 is a rear perspective view of a chair with the seated patient positioner of the FIGS. 18-19 positioned on the chair with an end segment of the seated patient positioner engaged in the chair.

FIG. 24 is a front perspective view of the seated patient positioner of the previous figures positioned on a chair and ready to receive a patient.

FIG. 25 is a top perspective view of the inside of the patient-facing portion of the seated patient positioner shown in the previous figures.

FIG. 26 is an end view of patient-facing portion open to show an inflated component inside the seated patient positioner shown in the prior figures.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

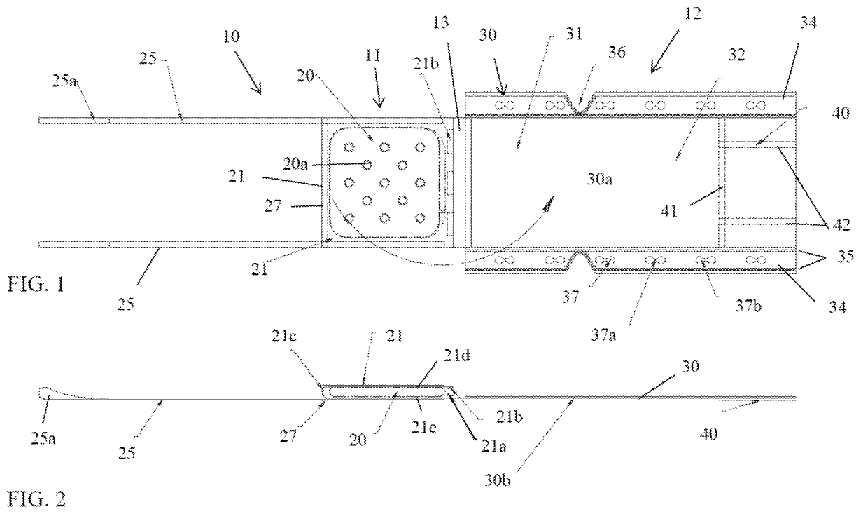

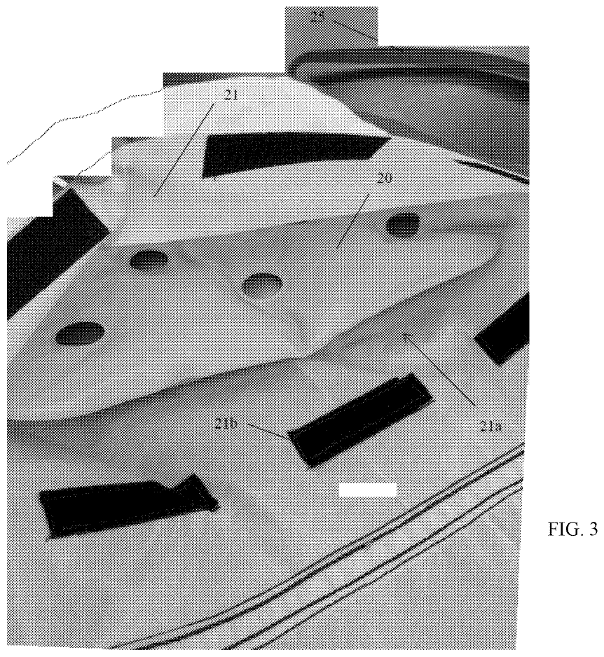

A seated patient positioner 10, shown in FIGS. 1-2, includes a seating segment 11 and a base segment 12, separated by a fold segment 13. The seating segment 11 includes a cushion case 21 that houses an off-loading element that is configured to reduce the pressure forces experienced by the patient while seated. In one embodiment the off-loading element is a static air cushion 20, but could be other components such a foam or a gel component configured to provide similar off-loading benefits. In one specific embodiment, the air cushion can be the WAFFLE™ cushion of EHOB, Inc. with venting holes 20a for airflow and moisture control. The static air cushion 20 redistributes the pressure of a patient sitting on the seating segment 11 to prevent pressure injuries to the patient. In particular, the WAFFLE™ cushion of EHOB, Inc. is configured to contour and cradle the patient seated on the positioner 10, so that the patient effectively sits in, and not on, the cushion. In one embodiment, the cushion case 21 includes an opening 21a for insertion and removal of the air cushion, as best shown in FIG. 3. The opening includes a reclosable closure 21b, such as an array of hook-and-loop fasteners, a zipper or other suitable closing mechanism. In another embodiment, the off-loading element is non-removably fixed within the cushion case.

The seating segment 11 includes a pair of boosting straps 25 sealed to the sides of the cushion case 21 and extending outward from the seating segment. The ends of the boosting straps include handle loops 25a that are sized to be manually grasped by the care giver. Each handle loop can also be sized so that a caregiver can extend an arm through the loop to engage the loop at the shoulder to provide a greater mechanical advantage when the caregiver is lifting or moving a seated patient. In one embodiment, the straps 25 are formed of heavy-duty webbing, such as a nylon webbing. Reinforcement webbing 27 extends between the straps at the end 21c of the cushion case 21 to prevent tearing of the cushion case during use of the boosting straps 25.

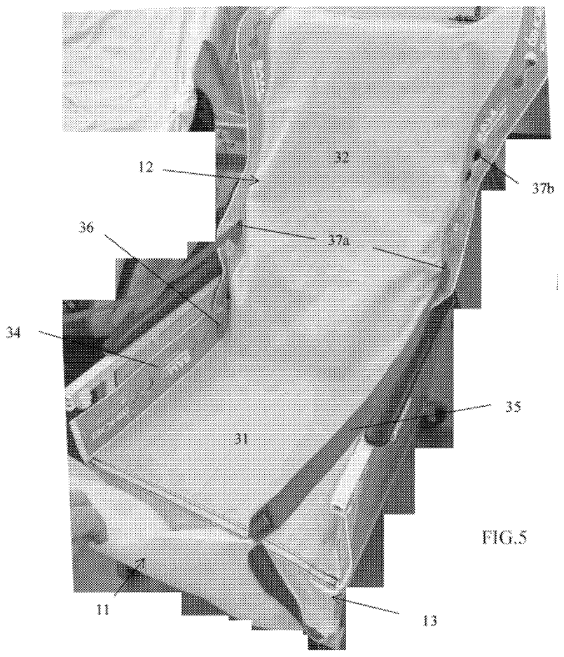

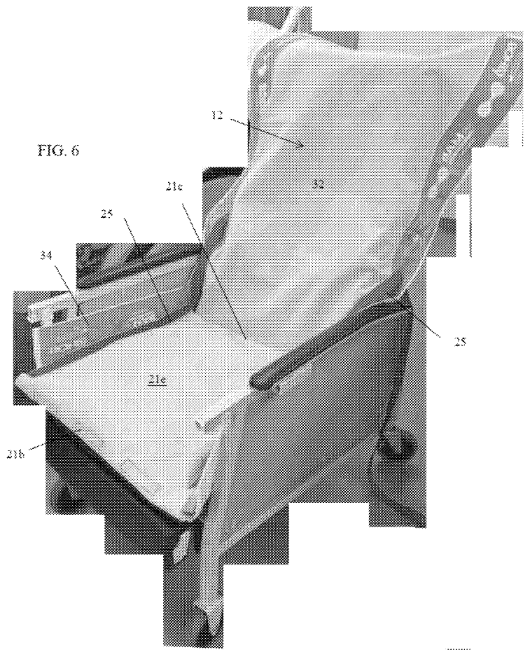

The base segment 12 of the seated patient positioner 10 can be configured as a patient transfer sheet, such as the BAM Pro of EHOB, Inc. In particular, the base segment can be constructed in the manner disclosed in U.S. patent application Ser. No. 18/902,218, entitled “Patient Positioning and Transfer Sheet” and filed by the present applicant on Sep. 30, 2024. The entire disclosure of the '218 Application is incorporated herein by reference for further details of the construction of the transfer sheet disclosed therein. For the present disclosure, the base segment 12 includes a core panel 30 with side strips 34 extending along the length of each side of the core panel. It is noted that the transfer sheet described in the '218 Application is sized for use on a bed, the core panel 30 of the present disclosure is sized to fit on a typical patient chair, as shown in FIGS. 5-6. Thus, the core panel can have a length of 30-50 inches and a width of 18-25 inches. The seating segment 11 is also sized to cover the seat of the hospital chair. In one embodiment, the seating segment 11 can be a 18-25 inch square. It is contemplated that a collection of seated patient positioners can be specifically sized for specific chair dimensions.

The core panel 30 can be formed of a non-woven material, such as polypropylene. The bottom surface 30b can be provided with a non-slip coating to resist slipping on the seat and back of the chair. In one embodiment, the bottom surface 30b can be formed of the same sheet as the seating surface 21e of the seating segment. The seating surface 21e faces the patient when the seating segment 11 is folded over onto the seat portion 31 of the base segment (FIG. 5), as shown in FIG. 6. The non-slip coating provided on the bottom surface 30b of the base segment 12 can be continued on the seating surface 21e to reduce the chance that the patient will slide forward when seated on the positioner.

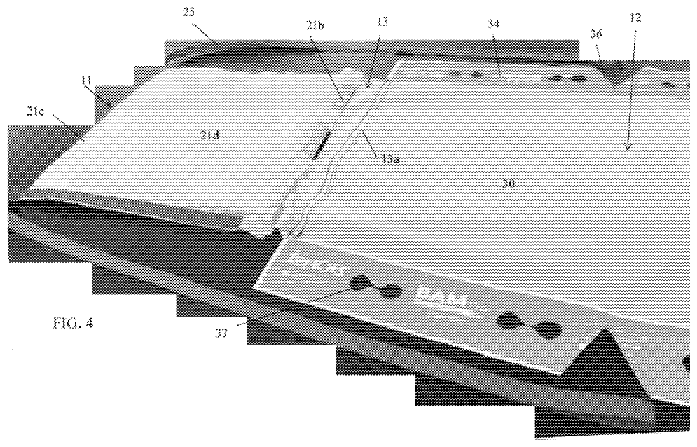

The top surface 30a of the base segment 12 can be provided with a surface that cooperates with the interface surface 21d of the seating segment 11 when the seating segment is folded over onto the seat portion 31 of the core panel 30, as shown in FIGS. 4-6. In particular, the two interfacing surfaces 30a, 21d can be configured to permit sliding of the seating segment 11 toward the seat back and to resist sliding of the seating segment away from the seat back. In addition, or alternatively, the interfacing surfaces can be provided with mechanical features or structure to resist movement of the seating segment away from the seat back.

As described in more detail in the '218 Application, the side strips 34 are affixed to the core panel 30 by seams 35 on each side of each side strip along the entire length of the core panel. The seams can be sewn or welded in a suitable manner. In a modification from the transfer sheet described in the '218 Application, the side strips 34 include a side notch 36 defined at the line of separation between the seat portion 31 and the back portion 32 of the core panel. The side notches prevent bunching of the core panel at the point where the panel is folded to fit onto the chair, as best seen in FIG. 5. The side notches allow the part of the side strip on the seat portion 31 to overlap the part of the side strip on the back portion 32.

The side strips 34 define a series of handles 37 spaced along the length of the core panel 30. The handles can be used to reposition a patient while seated or to turn a patient when the hospital chair is reclined. The handles can have a “dog bone” shape, as disclosed in U.S. Pat. No. 8,281,436, which issued on Oct. 9, 2012 to the applicant of the present application, the entire disclosure of which is incorporated herein by reference. As disclosed in the '436 Patent, the dog bone shape of the handles 37 do not result in material stress points when the handles are grasped by the care-giver and pulled outward to move a patient laterally. The handles 37 deform to a substantially circular shape so that the tangential stress at the handle is uniformly distributed around the circumference of the now circular shape.

In the illustrated embodiment, six handles are provided on each side of the core panel 30, spaced apart by about 8.5 inches to allow the care-giver to select the most comfortable and efficient placement of both hands when grasping and pulling the base segment 12. The handles are also positioned to provide an adjacent pair of feed-through handles 37a, 37b. As described in more detail herein, the boosting straps 25 can be looped through the adjacent pair of feed-through handles on each side of the positioner.

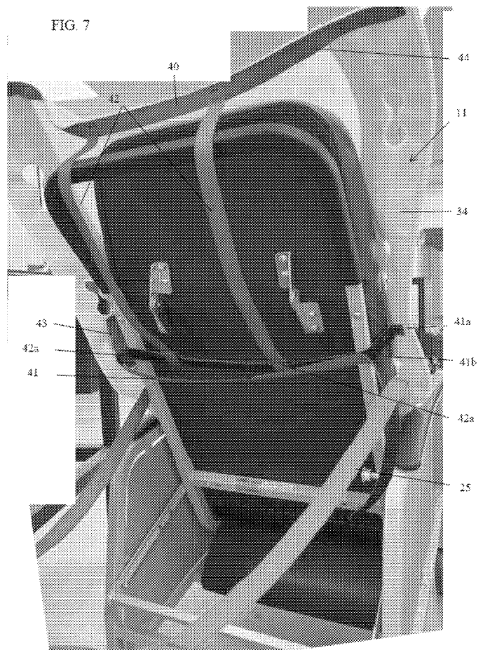

The seated patient positioner 10 is provided with a chair engagement feature that can engage the chair to prevent the positioner from being accidentally dislodged from the chair. In one embodiment, the base segment 12, and particularly the back portion 32, is provided with a harness 40 on the bottom surface 30b. The harness 40 includes a cross strap 41 attached at opposite sides of the core panel 30, and a pair of vertical straps 42 attached between the cross strap and the end of the back portion 32. As shown in FIG. 7, the harness 40 can fit over the top of the back of the chair to hold the seated positioner 10 in place on the chair. In the embodiment shown in FIG. 7, the cross strap 41 can be sewn at one end 41a to a side strip 34, and be fed through a loop 43 sewn to the other side strip, and then wrapped back toward the end 41a to engage itself at a hook-and-loop fastener 41b. The vertical straps 42 can be fixed to a reinforcement strip 44 extending across the width of the core panel and can be provided with loops 42a through which the cross strap 41 is fed. This configuration of the harness 40 allows the harness to adjust to different chair dimensions.

As shown in FIGS. 1 and 4, the seating segment 11 is connected to the base segment 12 by a fold segment 13. It can be appreciated that the fold segment 13 can be an extension of the cushion case 21 that is attached to the end of the core panel 30 at a seam 13a. Alternatively, the fold segment can be an extension of the core panel that is attached to the cushion case, or the core panel and cushion case can be formed as a continuous sheet that is folded and connected at seams as needed to define the components of the seated patient positioner 10. The width of the fold segment 13 is sufficient to allow the cushion case 21 and static air cushion 20 to lie flat on a seat portion 31 of the core panel 30 when the cushion case is folded over with the end 21c abutting the seat back, as shown in FIG. 6. In an intermediate step, the boosting straps 25 can be fed through the lowermost feed through handles 37a, as shown in FIG. 5. When the seating segment 11 is solidly seated on the core panel of the base segment 12, the straps 25 can be tucked between the cushion case 21 and the side strips 34 of the core panel that are folded up against the inside of the arms of the hospital chair. The handle loops 25a of the straps can be available at the back of the chair to be fed through the uppermost feed through handles 37b. When the straps are looped between the pairs of feed through handles 37a, 37b, the handle loops 25a are available at the front of the patient to help pull the patient upward and out of the chair.

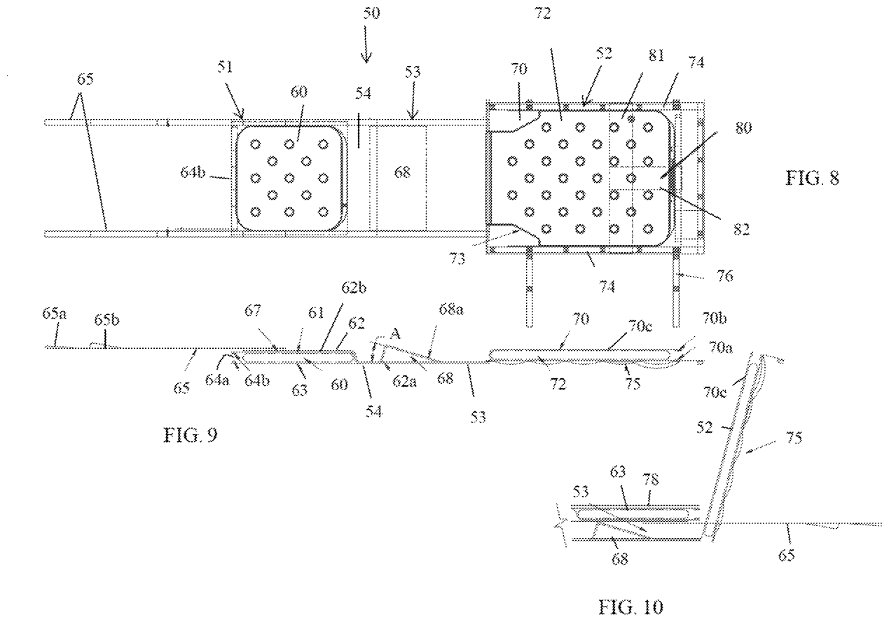

A seated patient positioner 50 is shown in FIGS. 8-10 that includes a wedge for positioning below the patient's thigh to provide resistance against the patient sliding forward on the chair. The positioner 50 includes a seating segment 51, a back segment 52, a base segment 53 connecting the seating segment 51 to the back segment 52, and a fold segment 54 connecting the seating segment 51 to the base segment 53. The base segment 53 is sized to fit on the seat of a hospital chair with the back segment 52 extending up the back of the chair. The seating segment 51 is similar to the seating segment 11 in that it includes an off-loading element 60 within a cushion case 61. The off-loading element can be a static air cushion, such as the WAFFLE™ cushion of EHOB, Inc. The cushion case 61 is formed by a cover sheet 62 that extends from the back segment 52, defines the surface for the base segment 53 and defines the top of the cushion case. A bottom sheet 63 is attached to the cover sheet 62 by stitching or seam welding to define the cushion case and an opening 64a for insertion and removal of the cushion 60. Unlike the cushion case 21 of the prior embodiment, the opening 64a of the cushion case 61 faces away from the base segment 53 of the positioner so that the wedge 68 in the base portion does not interfere with insertion and removal of the cushion. The opening 64a includes a reclosable fastener, such as a hook-and-loop fastener 64b, or other suitable closing mechanism. As with the patient positioner 10, the patient position 50 can include an off-loading element that is non-removably fixed within the cushion case 61.

The seating segment 51 includes a pair of boosting straps 65 extending from the cushion case 61, similar to the cushion case 21. A reinforcement webbing 67 can be provided to strengthen the cushion case to handle the loads applied at the boosting straps 65. The boosting straps can include the handle loops 65a at the end of the straps, as well as an intermediate loop 65b to provide an additional gripping feature for the caregiver.

In one feature of the seated positioner 50, the cover sheet 62 has different coatings applied to the top surface 62b and bottom surface 62a of the sheet. The bottom surface 62a is provided with a tacky feature to resist movement on the seat bottom. Thus, the bottom surface 62a is exposed at the base segment 53 of the positioner. The top surface 62b is exposed at the top of the cushion case 61 and is provided with a relatively slick feature which facilitates movement of the seating segment 51 on the wedge 68. In one specific embodiment, the cover sheet 62 can be a thermoplastic polyurethane (TPU)-coated nylon. The bottom sheet 63 provides the surface that is in direct contact with the patient when the seating segment 51 is folded at the fold segment 54 onto the base segment 53. Consequently, the bottom sheet 63 can be a foam sheet that enhances patient comfort. In use, an incontinence pad 78 can be placed on the bottom sheet 63 when the seating segment is folded over onto the base segment 53, as shown in FIG. 10. The foam properties of the bottom sheet prevents slippage of the incontinence pad.

The base segment 53 is sized to fit on and substantially cover the seat bottom of the hospital chair. The base segment includes the wedge 68 affixed to the cover sheet 62 and is located on the base segment so that the wedge is at the front of the chair seat when the positioner 50 is in the use position, as shown in FIG. 10. The wedge is angled upward toward the fold segment 54 or downward toward the back segment 52 at an angle A. The angle A is calibrated to resist the patient sliding forward on the chair without causing discomfort to the patient's thigh and knee. The angle can be in the range of 10°-20°, and in one specific embodiment, the angle A is 17°. The top surface 68a of the wedge is provided with a relatively slick surface, similar to the top surface 62b of the cover sheet 62. It is noted that the top surface 68a of the wedge interfaces with the top surface 62b of the seating segment 51, which means that the relatively slick top surface 62b contacts the relatively slick wedge surface 68a. This surface-to-surface contact allows for easy placement of the seating segment 51 onto the base segment 53 while the shape of the wedge provides protection against the patient sliding forward while seated on the chair.

The back segment 52 includes a cushion case 70 for receiving a removable cushion 72. The cushion case 70 includes an opening 70a at the end of the seated positioner 50 that allows insertion and removal of the cushion. The opening includes a reclosable closure 70b, which can include a hook-and-loop fastener. The front surface 70c of the cushion case 70 can be formed of the same foam material as the bottom sheet 63 for patient comfort.

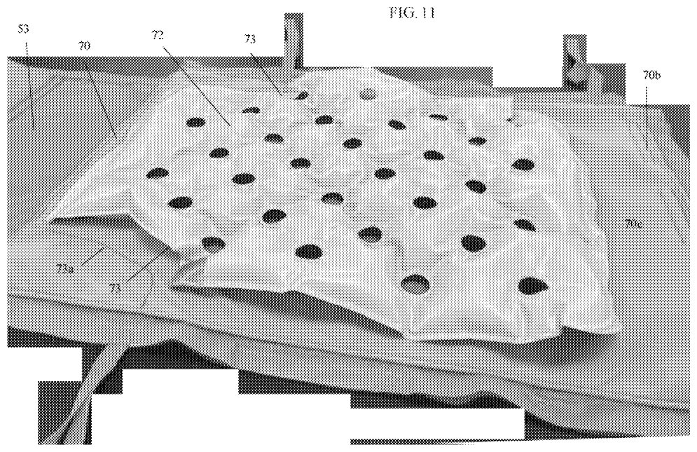

The cushion 72 can be a static air cushion, like the cushion 60. Since the cushion 72 will usually be vertically oriented at the back of a hospital chair, side indentations 73 are provided in both the cushion and in the cushion case 70. The cushion case 70 can incorporate complementary stitching 73a that follow the contour of the side indentations 73, as shown in FIG. 11. This helps anchor the cushion within the case, prevents bunching of the cushion and removes the parts of the cushion that do not provide a beneficial effect to the patient seated on the positioner 50.

The back segment 52 includes side strips 74 extending along the length of the segment (FIG. 8). Webbing handles 75 can be provided along the length of each side strip, along with a pair of side straps 76 projecting from opposite sides of the back segment, as shown in FIGS. 9-10. The side straps define handle loops at their respective ends to be manually grasped by the caregivers. Like the positioner 10, the seated patient positioner 50 includes a chair engagement feature to help hold the positioner on the chair. In this embodiment, the back segment can includes a harness 80 for securing the top of the back segment 52 to the top of the chair back, as shown in FIG. 15. In one embodiment, the harness can include an elastic cross strap 81 on the back face of the cushion case 70 and a vertical strap 82 connected between the cross strap and the open end of the cushion case.

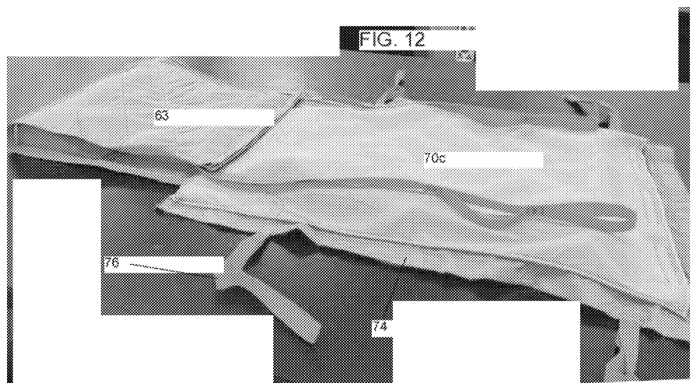

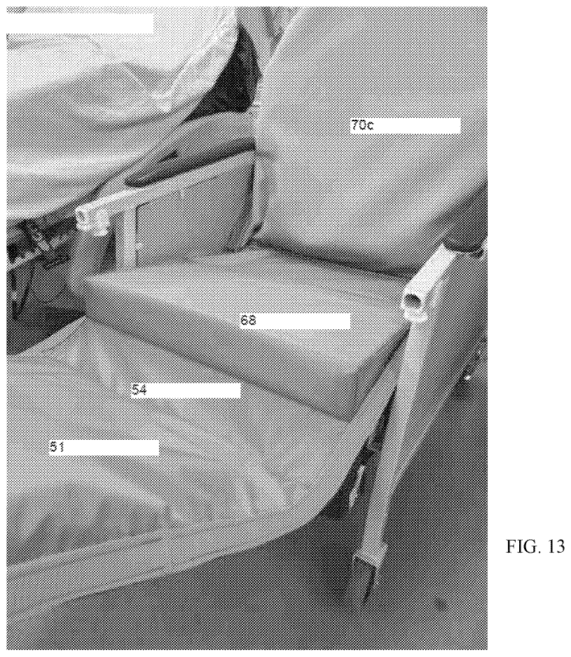

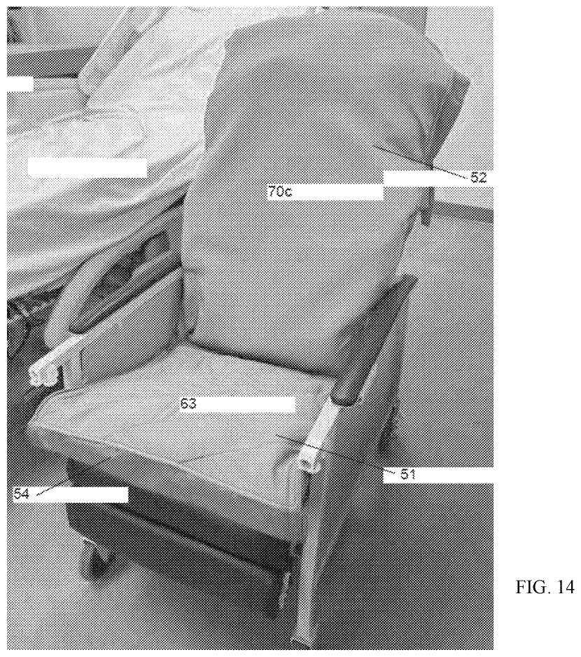

In use, the seating segment 51 is folded over at the fold segment 54 so that the cushion 60 is on the wedge 68, as shown in FIGS. 10 and 12. When the patient is seated on the seating segment, the cushion 60 will follow the contour of the wedge 68 until the top surface 62b contacts the base segment 53. As shown in the sequence of FIGS. 13-15, the positioner 50 is placed on the chair with the wedge 68 on the seat of the chair (FIG. 13), the seating segment 51 is folded over onto the wedge (FIG. 14), and the harness 80 is engaged around the back of the chair (FIG. 15).

It is noted that any of the static air cushions 20, 60 and 72, and wedge 68 can be formed of a moldable material that can be sculpted by contact with the patient to conform to the patient's anatomy. The moldable material can be a viscoelastic “memory” foam, a gel composition or a fluidized composition, which can retain its shape after sculpting. One example of a fluidized composition is the particulate composition disclosed in U.S. Pat. No. 9,504,621, which issued on Nov. 29, 2016.

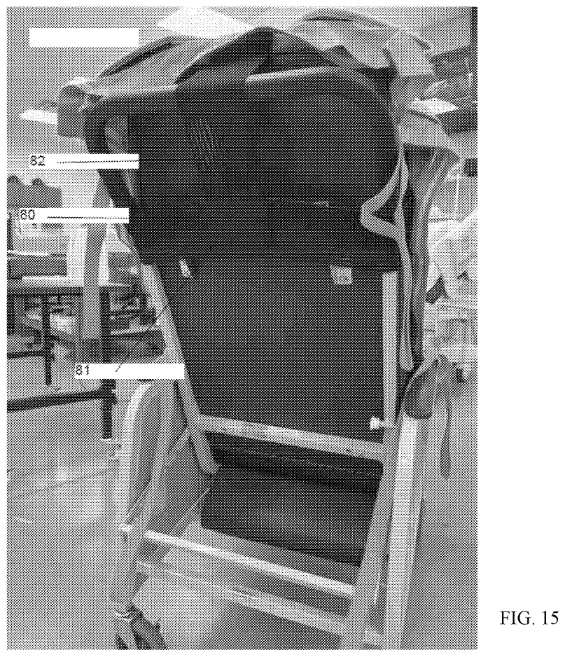

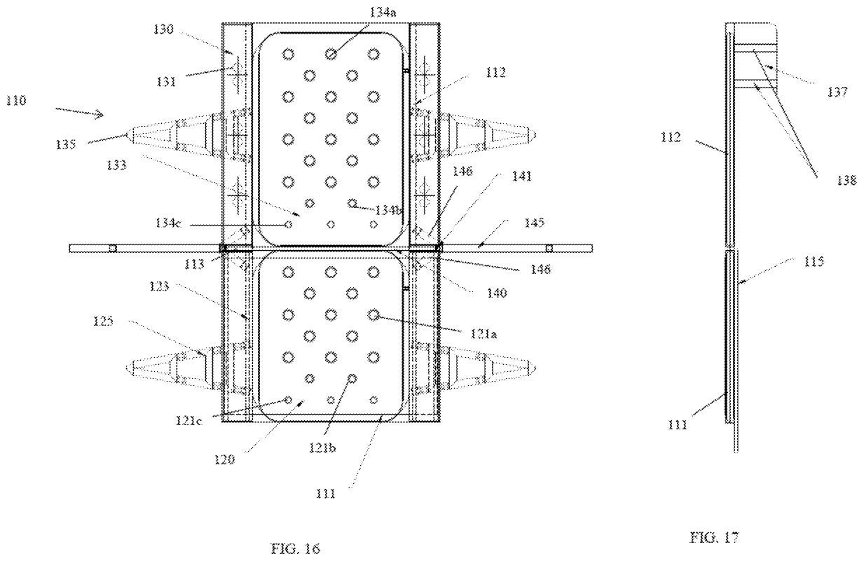

A seated patient positioner 110 shown in FIGS. 16-17 includes a seating segment 111 and a back segment 112 that are separated at a gap 140 at a fold segment 113. The seating segment includes side strips 123 extending along the length of the segment. Boost or lift straps 125 are anchored to each side strip and extend laterally outward from the seating segment for access by caregivers to lift the patient seated on the positioner 110. The seating segment 111 includes a static air cushion 120 similar to the static air cushions 20, 60. Thus, the air cushion can be the WAFFLE™ cushion of EHOB, Inc. with venting holes 121a, 121b, 121c for airflow and moisture control. Since the air cushion is sealed at the venting holes, the holes help restrict the amount of inflation of the cushion. In the prior embodiments, the venting holes, such as holes 20a, are uniformly distributed and are of uniform diameter so that the inflated height of the cushion is generally uniform. In the embodiment of FIG. 16, the venting holes 121a have a uniform diameter and are distributed in a portion of the cushion adjacent the fold segment 113. The venting holes 121b have a smaller diameter and are provided in a single row adjacent the venting holes 121a. The venting holes 121c have an even smaller diameter and are provided in a single row adjacent the free end of the cushion. The configuration of the venting holes 121b, 121c allow the cushion 120 to have an increasing inflated height toward the free end of the seating segment 111. This increased height at the front end of the seating segment helps prevent the patient from sliding forward on the patient positioner 110.

The back segment 112 includes side strips 130 that are aligned with the side strips 123 of the seating segment. The side strips 130 can include dog bone handles 131 along the length of the strips to provide multiple grasping points for the caregiver on the back segment as needed to manipulate the patient positioner. The side strips 130 provide the anchor point for additional boost straps 135 that are configured like the boost straps 125 of the seating segment. The two sets of boost straps 125,135 on opposite sides of the patient positioner can be grasped by caregivers on each side of the chair to help reposition the patient in the chair or lift the patient to help the patient move from the chair. The back segment 112 further includes a static air cushion 133 similar to the static air cushions 20, 60, 120. Thus, the air cushion can be the WAFFLE™ cushion of EHOB, Inc. with venting holes 134a, 134b, 134c, similar to the venting holes 121a, 121b, 121c.

The side strips 123, 130 provide a connection between the two segments 111, 112. In addition, an elastic band 141 is fixed between the respective side strips to bridge the gap 140 between the two segments. The elastic bands 141 are flexible so that the patient positioner 110 can be folded with the seating segment on the seat of the chair and the back segment 112 on the back of the chair. The gap 140 allows the two segments to move independently, while the elastic bands 141 control the movement and draw the two segments back together. Thus, the bands 141 limit gradual movement of the seated patient toward the front of the chair, while still allowing normal micro-movements of the patient. The elastic bands 141 provide a spring-back force when the patient is seated on the positioner that encourages a more upright posture of the patient. In addition, the same spring-back force that helps the caregiver reposition the patient on the positioner 110. It is contemplated that a single elastic band can span the width of the two segments 111, 112, or two or more elastic bands can be connected across the gap 140 and along the width of the segments.

The back segment 112 can be held in place against the back of the chair by a rear pocket 137 that fits over the top of the chair back. One or two elastic bands 138 can encircle the pocket to allow the pocket to engage different profiles for the seat back. With the back segment 112 effectively held in place on the chair back, most of the movement between the two segments 111, 112 will be the seating segment 111 moving forward and backward on the seat bottom as the patient moves on the chair. The elastic bands 141 spanning the gap 140 are sufficiently flexible to permit some relative movement, but are calibrated to draw the seating segment, and the patient seated thereon, back toward the chair back and back segment 112. The relative movement between the two segments can be further controlled by lifting straps 145 at the gap 140, each of which include an anchor leg 146 connected to a respective side strip 123, 130 that can further limit the movement of the two segments away from each other.

In another feature of the seated patient positioner 110, a slip layer 115 can be placed between the underside of the seating segment 111, as shown in FIG. 17, and the surface of the chair bottom. The slip layer has a coefficient of friction that allows the seating segment to slide more easily on the chair even with the patient seated on the positioner. This feature can simplify assisting the patient when standing up from the chair, with the assistance of the caregivers using the boost straps 125, 135 and/or lift strap 145.

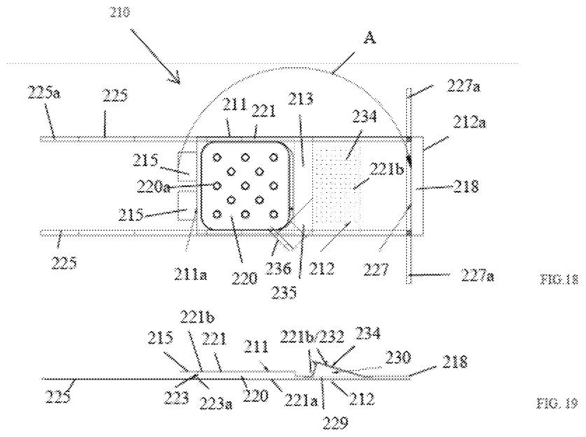

A seated patient positioner 210, shown in FIGS. 18-19, according to another embodiment, includes a seating segment 211 and a base segment 212, separated by a fold segment 213. The seating segment 211 includes a cushion case 221 that houses a static air cushion 220, similar to the patient positioner 10 in FIG. 1. In one embodiment, the air cushion can be the WAFFLE™ cushion of EHOB, Inc. with venting holes 220a for airflow and moisture control. The static air cushion 220 redistributes the pressure of a patient sitting on the seating segment 211 to prevent pressure injuries to the patient. In particular, the WAFFLE™ cushion of EHOB, Inc. is configured to contour and cradle the patient seated on the positioner 210, so that the patient effectively sits in, and not on, the cushion. In one embodiment, the cushion case 221 includes an opening 223 for insertion and removal of the air cushion, as best shown in FIG. 26, and which can include a reclosable closure 223a, such as a zipper, an array of hook-and-loop fasteners or another suitable closing mechanism.

As indicated by the arrow A in FIG. 18, the seating segment 211 is folded at the fold segment 213 over the base segment 213. In this arrangement, the outer sheet 221a of the cushion case 221 is facing the patient. In one embodiment, the outer sheet 221a can be provided with a higher friction or gripping surface so that the seated patient does not slip when seated on the seating segment 211. The gripping surface can be provided by the type of fabric with a friction-enhancing surface texture or by a slightly tacky coating. In some embodiments, the gripping surface of the outer sheet 221a can be provided along the entire length of the positioner, including on the exterior of the base segment 212 so that the positioner does not slip on the surface of the chair on which the positioner is seated.

In another specific embodiment, the outer sheet of the seating segment 211 can incorporate regions with different friction or gripping features. Thus, as shown in FIG. 27, the outer sheet 221a′ can include two regions—one region 222a having a coefficient of friction or a tackiness that is less than the region 222b. In this embodiment, the friction or tackiness is greatest at the knee-thigh region of the patient (i.e., at the front end 210a of the patient positioner that is adjacent the front of the chair) and lowest near the buttocks or sacral region (i.e., at the back end 210b of the patient positioner that is adjacent the back of the chair). In the normal seated position, the patient's thighs will be positioned within the lower friction region 222a. But, as the patient begins to slip forward on the seating segment, the thighs and buttocks will contact the higher friction region 222b. The farther the patient moves into the higher friction region 222b, the greater the friction force because the perpendicular load increases as more of the patient's body weight is borne by the higher friction region. The higher friction regions thus serves to limit the forward movement of the patient while seated. The lower friction region 222a is defined in the region where the patient will optimally be seated, so the lower friction or tackiness permits normal micro-movements of the patient when seated. In the embodiment depicted in FIG. 27, the higher friction region 222b is essentially triangular with the base of the triangle adjacent the front end 210a of the patient positioner and the tip of the triangle in the middle region of the outer sheet 221a′. It can be appreciated that this triangular configuration of the higher friction region 222b splits the lower friction region 222a into two lateral legs that converge to span the entire width of the outer sheet 221a′ at the back end 210b of the positioner.

It is contemplated that the friction or tackiness of the two regions 222a, 222b of the outer sheet 221a′ can be accomplished by differences in the thread configuration of the outer sheet or by coatings selectively applied to the surface of the outer sheet. The friction or tackiness feature can be binary, meaning that the entire low friction region 222a has the same coefficient of friction; tackiness, and the entire high friction region 222b has the same greater coefficient of friction/tackiness. Alternatively, the friction/tackiness of either or both regions 222a, 222b can vary across a dimension of the region. Thus, the friction/tackiness in the high friction region 222b can gradually increase toward the front of the chair so that the friction/tackiness is greatest when the patient is closest to the front edge of the chair. In one embodiment, the low friction region 222a can be provided by a nylon coating and the high friction region 222b can be formed by a thermoplastic polyurethane (TPU) coating on outer sheet 221a′. As an alternative, the outer sheet 221a′ can be formed of either the low friction or the high friction material, with the other material provided as a coating. For example, the outer sheet 221a′ can be formed of nylon with a triangular coating 222b of TPU.

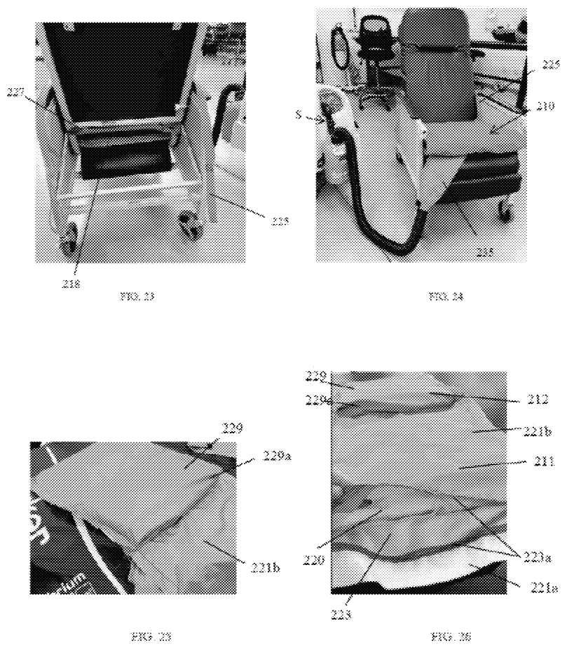

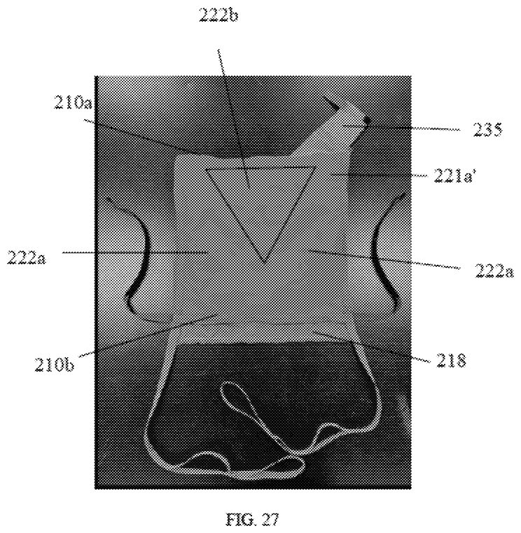

Returning to FIG. 18, the seating segment 211 includes a pair of boosting straps 225 that extend along the opposite sides of the positioner 210 and outward beyond the front end 211a of the seating segment, similar to the positioner 10 of FIG. 1. The ends of the boosting straps include handle loops 225a that are sized to be manually grasped by the caregiver. Each handle loop can also be sized so that a caregiver can extend an arm through the loop to engage the loop at the shoulder to provide a greater mechanical advantage when the caregiver is lifting or moving a seated patient. In one embodiment, the straps 225 are formed of heavy-duty webbing, such as a nylon webbing. A transverse strap 227 extends between the straps 225 adjacent the end 212a of the base segment 212. The transverse strap 227 is sized to fit around the back of the seat portion of the chair, as shown in FIG. 23, with ends 227a configured for removable engagement, such as with hook-and-loop fasteners.

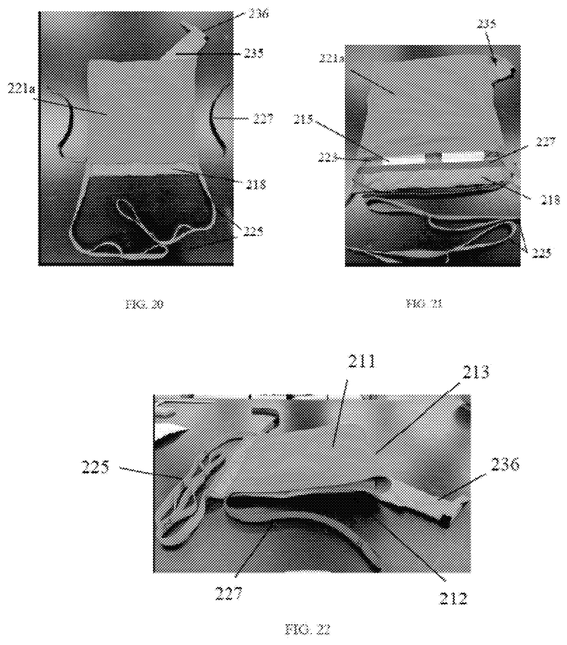

It can be appreciated that folding the seating segment 211 onto the base segment 212 is part of the manufacture of the patient positioner 210, so that the positioner appears as shown in FIGS. 20-23 when in use. The cushion case 221 includes a pair of wide elastic flaps 215 that are initially fixed at one end to the cushion case, as shown in FIG. 18. Then, when the seating segment is folded over the base segment, the opposite ends of the two flaps 215 are sewn to the transverse strap 227, as shown in FIG. 21. In the final assembled configuration, the sides of the positioner are open, as best seen in FIG. 22, with the seating segment 211 overlapping the base segment 212. The elastic flaps limit the relative movement between the seating segment 211 and the base segment 212 when the patient is seated on the positioner, while still retaining the repositioning and patient transfer characteristics of the positioner 210.

The base segment 212 of the seated patient positioner 210 is integrated with the seating segment 211, with the inner sheet 221b and outer sheet 221a forming the two segments being continuous from the front end 211a of the seating segment 211 to the back end 212a of the base segment. The inner and outer sheets can be nylon or polyurethane-coated nylon, with the bottom sheet 221a having the tacky surface as described above. The base segment includes a wedge 230 sewn into a casing 229 formed by the two sheets 221a, 221b at the base segment. The wedge 230 is arranged to be positioned at the front of the chair when the positioner is mounted on the chair so that the patient's thighs are supported by the wedge. The wedge 230 is angled rearward (toward the back of the chair) to induce the patient toward the back of the chair and help prevent the patient from slipping forward. In one embodiment, the wedge 230 can have a length from front to back of 5-6 inches and an angle of 5 -15 degrees. The wedge 230 can also be formed of a conforming material, or a “memory foam” material, for the comfort of the patient.

The transfer aspect of the base segment 212 is enhanced by an aperture array 234 in the inner sheet 221b of the casing 229, as shown in FIG. 18. An additional sheet 232 is positioned between the top surfaces of the wedge 230 and inner sheet 221b to prevent boosting air from flowing into the foam material of the wedge. The aperture array 234 includes a plurality of small apertures that allow air to escape through the inner sheet 221b to form an air cushion between the base segment 212 and the seating segment 211. In one embodiment, the additional sheet 232 extends over the length of the wedge 230 and partially into the fold segment 213, as shown in FIG. 19, although the aperture array can be limited to the region of the wedge. The aperture array can include 16 rows of nine apertures (totaling 144 apertures), each having a diameter of 0.05 in. (1.2mm). A tubular air intake sock 235 has one end that is in communication with the interior of the casing 229, with an inlet fitting 236 at an opposite end that is configured to be connected to an air supply S, as shown in FIG. 24. During normal use the sock 235 is not connected to an air supply, so the casing 229 does not inflate and no air passes through the aperture array 234. However, when it is desired to reposition the patient on the chair, or transfer the patient from the chair, the sock 235 can be connected to an air supply so that the casing 229 becomes slightly inflated and air flows through the aperture array 234 to form an air cushion underneath the patient. This air cushion simplifies the task of the patient care personnel as the patient is repositioned since the “air-hockey effect” causes offloading and generates a small amount of lift which reduces the force need to move the patient.

In another feature of the base segment 212, the top and bottom sheets 221a, 221b are sewn together to define an end segment 218 that extends beyond the transverse strap 227, as shown in FIGS. 18-21. It is noted that the seated patient positioner 210 of FIGS. 18-19 differs from the patient positioner 10 of FIGS. 1-2 in that base segment 212 of the positioner 210 does not extend along the back of the seat, unlike the base segment 12. Instead, the end segment 218 is configured to be tucked into the chair such as between the seat and back of the chair, as shown in FIG. 23, or between the seat and the frame of the chair. This feature helps anchor the seated positioner 210 to the chair, assisted by the transverse strap 227, to prevent the positioner, and the patient, from sliding off the chair.

In one aspect in the manufacture of the seated patient positioner 210, the casing 229 can be formed by sewing the top and bottom sheets 221a, 221b together at front end 229a of the case to form loose pleats. The pleats are expanded when the triangular wedge 230 is introduced into the case, with the tall end of the wedge moving the top and bottom sheets apart to remove the pleats. This feature accommodates the triangular wedge without requiring triangular side walls between the top and bottom sheets 221a, 221b.

The present disclosure should be considered as illustrative and not restrictive in character. It is understood that only certain embodiments have been presented and that all changes, modifications and further applications that come within the spirit of the disclosure are desired to be protected.

What is claimed is:

1. A seated patient positioner for placement on a chair, comprising:
a seating segment including a static air cushion removably disposed within a reclosable cushion case, a seating surface which contacts the patient when the patient is seated on the positioner and an opposite interface surface, wherein the seating segment is sized to substantially cover the seat of the chair;
a base segment including an elongated sheet sized to at least substantially cover the seat of the chair, the elongated sheet having a top surface and an opposite slip-resistant bottom surface which contacts the seat of the chair when the seated patient positioner is placed on the chair and provides a friction surface to resist slipping between the base segment and the seat of the chair;
a fold segment connecting said seating segment and said elongated sheet of said base segment and configured for the seating segment to be folded over onto the base segment with the interface surface in contact with the top surface of the base segment; and
a chair engagement feature for engaging the seated patient positioner to the chair to resist dislodgment of the positioner from the chair.

2. The seated patient positioner of claim 1, further comprising an elongated strap extending along opposite sides of said reclosable case from said fold segment away from said base segment and beyond an end of said seating segment opposite said fold segment, each elongated strap including a handle loop sized to be manually grasped by a caregiver.

3. The seated patient positioner of claim 1, wherein said elongated sheet of said base segment has a length sized to substantially cover the seat and the back of the chair.

4. The seated patient positioner of claim 3, wherein said elongated sheet includes handles integrally formed at opposite sides of said sheet along the length of the sheet.

5. The seated patient positioner of claim 3, wherein said elongated sheet defines a notch at opposite sides of said sheet between a seating portion of said sheet that covers the seat of the chair and a back portion of said sheet that covers the back of the chair.

6. The seated patient positioner of claim 3, wherein said chair engagement feature includes a harness at an end of said elongated sheet opposite said fold segment, said harness configured to engage the back of the chair.

7. The seated patient positioner of claim 3, further comprising a wedge disposed between said fold segment and said base segment and arranged for said seating segment to be folded over onto said wedge, wherein said wedge is angled upward toward said fold segment.

8. The seated patient positioner of claim 7, wherein said wedge is angled at an angle of 10°-20°.

9. The seated patient positioner of claim 3, wherein:
said base segment includes a seating portion and a back portion that covers the back of the chair; and
said back portion includes a second static air cushion removably disposed within a second reclosable cushion case.

10. The seated patient positioner of claim 9, wherein said second static air cushion and said second reclosable cushion case include complementary side indentations at opposite sided thereof adjacent to said seating portion of said base segment configured to prevent bunching of said second reclosable cushion case adjacent said seating portion.

11. The seated patient positioner of claim 9, further comprising a plurality of elongated straps extending from opposite sides of said back portion, said elongated straps defining a handle loop configured to be manually grasped.

12. The seated patient positioner of claim 1, wherein said fold segment includes a gap between said seating segment and said elongated sheet of said base segment and at least one elastic band spanning said gap and connecting said seating segment and said elongated sheet of said base segment.

13. The seated patient positioner of claim 1, wherein said seating surface includes two regions having different coefficients of friction, with a first region extending from a back end of said seating segment toward an opposite front end, and a second region extending from said front end to a middle portion of the seating surface, wherein the second region has a greater coefficient of friction than the first region.

14. The seated patient positioner of claim 13, wherein said second region is triangular with the base of the triangle adjacent said front end of the seating segment.

15. The seated patient positioner of claim 13, wherein said seating surface in said first region is formed of nylon and said seating surface in said second region is formed of a thermoplastic polyurethane (TPU).

16. A seated patient positioner for placement on a chair, comprising:
a seating segment including a static air cushion removably disposed within a reclosable cushion case, a seating surface which contacts the patient when the patient is seated on the positioner and an opposite interface surface, wherein the seating segment is sized to substantially cover the seat of the chair;
a base segment sized to at least substantially cover the seat of the chair, the base segment including a bottom sheet for contacting the seat of the chair and a top sheet forming a casing with said bottom sheet, said casing connected to a tubular air intake sock connected at one end thereof to an interior of said casing and including an inlet fitting at an opposite end configured to be connected to an external air supply;
a fold segment connecting said seating segment and said bottom sheet of said base segment and configured for the seating segment to be folded over onto the base segment with the interface surface in contact with the top surface of the base segment; and
a chair engagement feature for engaging the seated patient positioner to the chair to resist dislodgment of the positioner from the chair,
wherein said top sheet includes a plurality of apertures for flow of air from the interior of said casing, when air is provided through said air intake sock, to form an air cushion between said base segment and said seating segment when said seating segment is folded over onto said base segment.

17. The seated patient positioner of claim 16, further comprising a wedge disposed within said casing of said base segment and arranged for said seating segment to be folded over onto said wedge, wherein said wedge is angled upward toward said fold segment.

18. The seated patient positioner of claim 17, wherein said wedge is angled at an angle of 10°-20°.

19. The seated patient positioner of claim 17, wherein said casing includes a sheet interposed between said top sheet and said wedge to prevent air flow onto said wedge.

20. The seated patient positioner of claim 16, wherein said top sheet includes a plurality of rows with a plurality of apertures in each row.

21. The seated patient positioner of claim 20, wherein said top sheet includes sixteen (16) rows of nine (9) apertures totalling 144 apertures in said top sheet.

22. The seated patient positioner of claim 16, wherein said bottom sheet of said base segment includes a slip-resistant surface which contacts the seat of the chair when the seated patient positioner is placed on the chair and provides a friction surface to resist slipping between the base segment and the seat of the chair.
